(19) United States
(12) Patent Application Publication
(10) Pub. No.: US 2017/0205060 A1
(43) Pub. Date: Jul. 20, 2017

(54) FLEXIBLE OLED PANEL FASHIONED TO RESEMBLE A LAMP SHADE

(71) Applicant: Matthew Kennedy, Chilliwack (CA)

(72) Inventor: Matthew Kennedy, Chilliwack (CA)

(73) Assignee: LOOM INC., Chilliwack, BC (CA)

(21) Appl. No.: 15/119,759

(22) PCT Filed: Jan. 22, 2015
(86) PCT No.: PCT/CA2015/050043

§ 371 Date: Aug. 18, 2016

(30) Foreign Application Priority Data
Feb. 20, 2014 (CA) 2843101

(51) Int. Cl. F21V 21/116; F21V 23/06; F21S 6/00; F21V 1/16

(52) U.S. Cl. CPC F21V 21/116; F21V 1/16; F21V 23/06; F21S 6/002; F21Y 2115/15

(57) ABSTRACT

A flexible organic light emitting diode (“OLED”) and method of assembly to facilitate the use in a lighting luminaire and appear like a traditional cone shaped lamp shade. Flexible OLED panels, manufactured with a certain pattern or design resembling an unrolled and flattened conic frustum, allow the flexible panel to be curled, during assembly, to create a cone shape by bringing two ends of the panel together and resemble a traditional cone shaped light shade. Auxiliary frames or tensioning ties can be placed on the cone shaped OLED panel to retain the shape of the cone or, in instances where a portion of the OLED panel extends beyond the cone form in assembly, a lap joint can be made with two ends of the panel and secured with an adhesive. Frames may aid in the suspension of the OLED panel, as desired, to serve as a luminaire or lighting fixture.

This application is a National Stage completion of PCT/CA2015/050043 filed Jan. 22, 2015, which claims priority from Canadian patent application serial no. 2,843,101 filed Feb. 20, 2014.

### SUMMARY OF THE INVENTION

Flexible organic light emitting diode (“OLED”) panels are an emergent technology. The invention describes the design and method of assembly of a flexible OLED panel having a truncated conical form when fully assembled to create the appearance of a traditional cone shaped light shade with the OLED panel. The invention takes advantage of the flexible nature of flexible OLED technology, allowing the OLED panel to be manufactured flat and then curled into the desired shape during assembly. When assembled, the flexible OLED panel appears to be a truncated cone with an interior surface facing toward the axis of the cone and an exterior surface facing away from the axis of the cone and having apertures at opposite ends of the axis providing an unobstructed tunnel through the assembled OLED panel within the volume bounded by the interior surface and said apertures. In the preferred embodiment of the invention, the cone shaped form in the assembly will have a smaller aperture at one end and a larger aperture at the other end that together comprise the top and bottom apertures respectively, in typical use. As the OLED panel has a flat state at manufacture and a curled cone shape at assembly that resembles a lamp shade in use, the terms OLED panel, OLED cone and OLED shade are used interchangeably to refer to different states of the same invention.

The cone form of the OLED panel can be described as a portion of a nappe, or the cone shape below the apex of a conic surface. The truncated nature of the cone eliminates the cone coming to a point at one end, giving ample relief to the flexible OLED panel to curl as the technology has limited bend radii and cannot be too tightly curled without damaging the OLED panel. The appearance of the cone shaped OLED panel at assembly can resemble a frustum, or a cone with parallel openings at the top or bottom end, perpendicular to the axis of the cone, however these apertures can also be conic in shape, such as ellipses, whereby the theoretical plane at the aperture is not perpendicular to the axis.

The invention may also appear to be a cylinder, which is considered to be a special kind of cone in mathematics; in this embodiment of the invention the opposing apertures can be equal in size and appearance if they are both circles or are both ellipses of equal dimension. The flat pattern of the OLED panel would be a rectangle in embodiments where the OLED cylinder has opposing apertures of equal size nominally perpendicular to the axis of the cylinder.

OLED panels typically emit light uni-directionally, that is from only one side or major surface, so when the light emitting surface of the panel is oriented toward the interior of the OLED cone in assembly the finished product aids in glare control by limiting the amount of direct light perceived by a viewer as light only emits from the cone's apertures. Some OLED panels also emit light bi-directionally, that is from both sides (both major surfaces), and in this manner the finished product would emit light from both the interior and exterior surfaces of the cone, which is desirable in some applications. Variations of bi-directional OLED panels emit light more intensely from one side than the other so, in instances where the more intense emitter faces interiorly toward the axis of the cone, the invention is considered to provide glare control by limiting the more intense light emission via the top and bottom apertures from the interior side of the invention; in this fashion the invention is considered to most resemble a traditional light shade in function as well as appearance.

The lamp shade shape of the invention is facilitated by manufacturing the flexible OLED panel with a curved flat pattern resembling an unrolled and flattened truncated conic or frustum, comprised of a curved inner contour edge and a curved outer contour edge and two generally straight joint edges at opposing ends of the contours, in the preferred embodiment. The edge or edges that each comprise the inner and outer edges of the OLED panel can be several straight edges joined together to form said edges, following a nominally curved line. The particular shape of the panel's flat pattern allows the OLED panel to form a truncated cone when the straight edges, or joint edges, are brought together as the flexible panel is curled into shape during the assembly. The joint edges are straight in the preferred embodiment of the invention, so that they form a simple seam when they are brought together. Joint edges may be alternatively curved or otherwise fashioned for cosmetic or assembly purposes.

During assembly, the joint edges are brought proximally together in a seam and are thereto fastened in relation to each other by fastening means to retain the cone shape during use. Fastening means in the preferred embodiment is comprised of hardware passing through holes, or assembly positions, in the OLED panel and into a frame that retain the shape of the curved OLED panel. Other embodiments may employ a lap joint, whereby the interior surface at one end proximal to the adjacent joint edge is fastened to the exterior surface at the opposing end proximal to its joint edge with an adhesive such as double sided adhesive tape, whereby the lamp-shade shape of the flexible OLED panel is retained. Lap joints can also be fastened together with hardware or frames. Likewise, a batten can be employed to join the seam of two joint edges proximal to each other in a scab joint with adhesive, hardware or frames. Frames may be comprised of wire, cast or machined aluminum, injection molded plastic or the like. The ends may also be tied together with ties passing through holes adjacent to the each end of the OLED panel; ties may refer to string, wire, or be comprised of said frames.

Framing may be employed to provide a means to join and retain the desired shape of the OLED shade in assembly at the joint seam, but can also be used to add structural rigidity to the apertures of the OLED shade or provide a means to support the shade in use as a luminaire, whether it be by suspension from the ceiling, mounting to a wall, or supporting from the floor. Conductors powering the OLED panel are found on opposing ends of the panel, either at inner edge and outer edge, or at joint edges. Conductors, typically in the form of low-voltage power connectors, can be found within edge borders that delineate the illuminating portion of the OLED panel and non-illuminating portions where conductors can be joined to the OLED panel. Since the OLED shade requires conductors to power the light emitter, said framing systems can employ means to conceal and protect said conductors, such as by way of a channel or conduit in a frame that can be securely closed during assembly, providing a protective passage for the conductors from the OLED panel to the power source. Likewise, OLED panels typically employ non-emitting portions or borders at opposing edges to mount the conductors to, which are desirably concealed behind a framing system.

### BRIEF DESCRIPTION OF THE DRAWINGS

FIG. 1 is a flat pattern of the flexible OLED panel of the present invention;

FIG. 2 is a perspective view of the present invention, showing how a cone is formed by bring two edges of the flat pattern together during assembly;

FIG. 3 is a top plan view of the present invention in assembly;

FIG. 4 is a side plan view of the present invention in assembly;

FIG. 5 is a front plan view of the present invention in assembly;

FIG. 6 is a perspective view of the present invention in assembly with a supporting frame and support means;

FIG. 7 is a top plan view of the present invention in assembly with a supporting frame showing the section line pertaining to image 10;

FIG. 8 is a perspective view of the present invention in assembly showing details of features of the OLED panel, including non-emitting borders, conductors, and assembly and mounting means;

FIG. 9 is an enlarged fragmentary view of the non-emitting borders and conductors;

FIG. 10 is a cross-sectional of the assembly with said supporting frame and supporting means of FIG. 7, revealing assembly means, power means and a conduit wherein conductors are connected to power means; and

FIG. 11 shows a perspective view of the frame supported by support means, in the form of a lamp-stand, showing an unobstructed view of the assembly means without the OLED shade or the mounting plate.

### DESCRIPTION OF THE PREFERRED EMBODIMENT

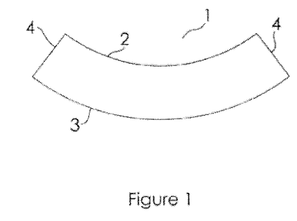

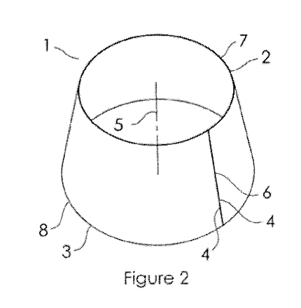

FIG. 1 describes the preferred embodiment of a flexible OLED panel 1, manufactured flat with an inner edge 2 and an outer edge 3, with two joint edges 4 between the inner edge 2 and outer edge 3; inner edge 2 and outer edge 3 are described as nominally curved in the preferred embodiment of the invention. When flexible OLED panel 1 is curled, bringing joint edges 4 proximally close together, or touching, said OLED panel 1 forms a truncated cone around axis 5, similar in appearance to a traditional lighting fixture shade, as shown in FIG. 2.

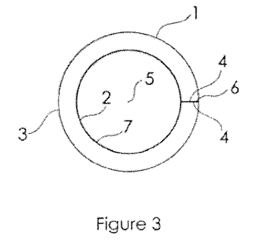

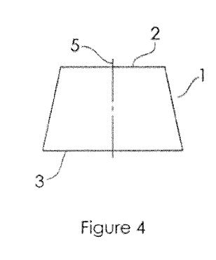

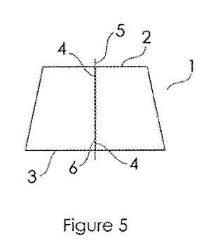

FIG. 2 describes a flexible OLED panel 1 curled into a truncated cone, or OLED shade, showing joint edges 4 proximally close together, where they form a seam 6, and shows inner edge 2 form a nominally circular small aperture 7, and outer edge 3 form a nominally circular large aperture 8 in the preferred embodiment. Small aperture 7 and large aperture 8 can be alternatively positioned in either upward or downward orientation, or in any direction, in the luminaire assembly, FIG. 3, FIG. 4 and FIG. 5 describes the top view, the side view and the front view of the preferred embodiment of the invention.

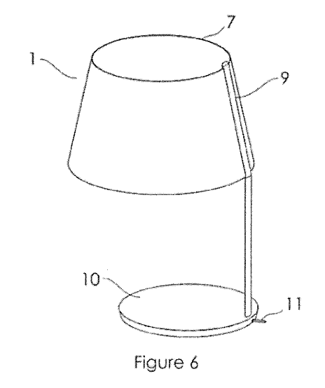

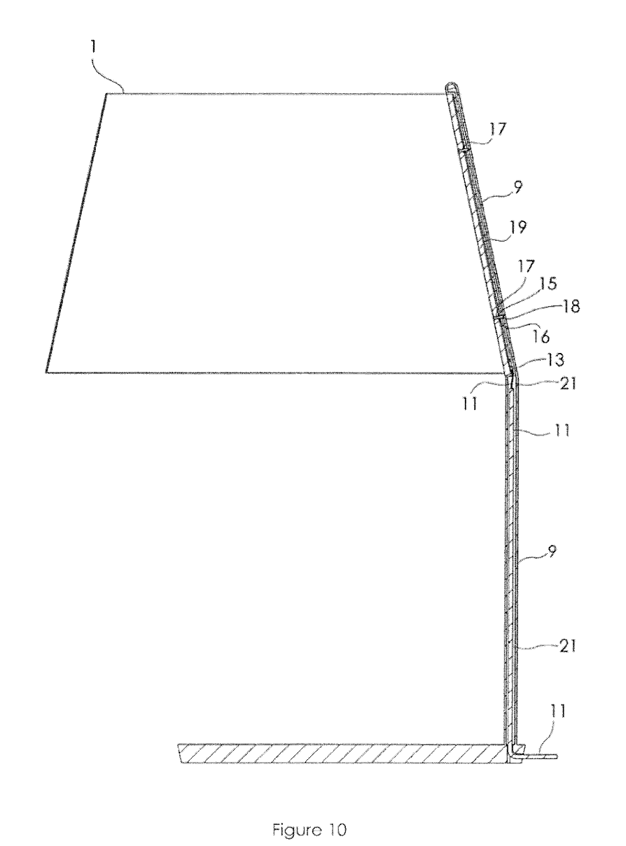

FIG. 6 describes an OLED shade 1 mounted to a frame 9 that is supported by support means 10, shown in the present embodiment as a lamp stand, but may also feature as a suspension cable or pendant and the like. Power source 11 is supplied to the OLED panel 1 by way of passage through channel 21 in frame 9, as seen in FIG. 10.

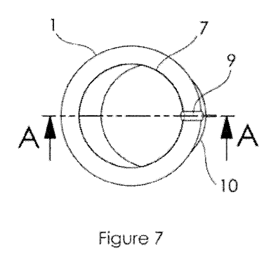

FIG. 7 describes an orthographic top plan view of OLED shade 1 mounted to a frame 9, showing the section view orientation for FIG. 10.

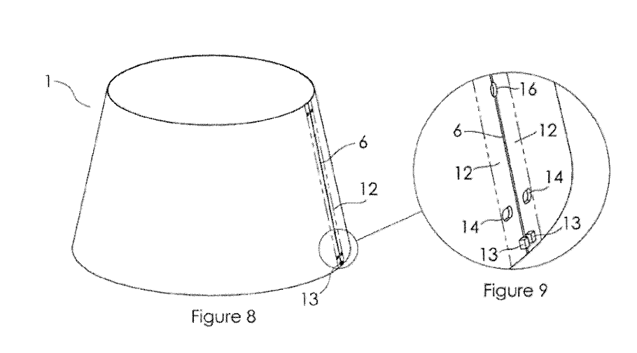

FIG. 8 describes an OLED shade 1 showing non-emitting borders 12 to which conductors 13 are mounted, in the form of low-voltage power connectors.

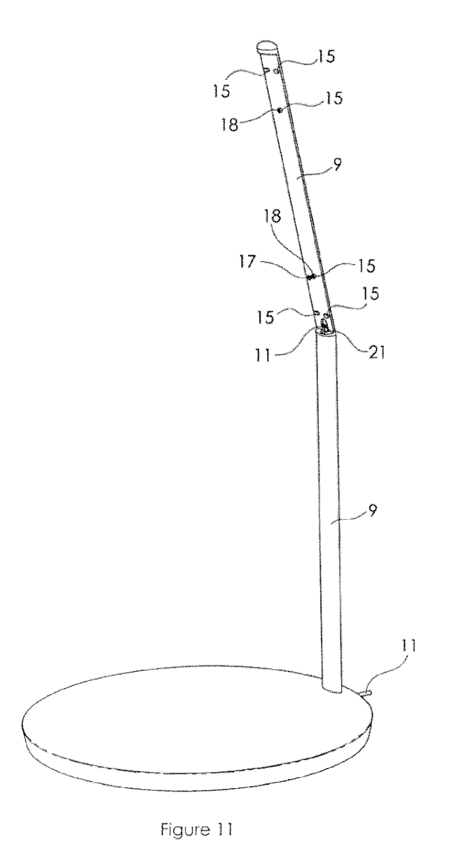

FIG. 9 is a detail view of the OLED shade 1 showing non-emitting borders 12, conductors 13, and assembly positions 14, in the form of holes in the preferred embodiment, disposed to provide a retention means with said frame by way of assembly posts 15, as seen in FIG. 11, on said frame to keep joint edges 4 proximally close together to retain the lamp-shade shape of the OLED panel. Relief notches 16 allow fastening means 17, such as hardware, to pass through the OLED shade 1 unobstructed and into a fastening position 18, such as a threaded hole, in an assembly post 15 in frame 9. In other embodiments, holes such as assembly positions 14 can be employed for mounting and assembly, where fastening means may likewise pass through said assembly positions 14 into fastening positions 18 in assembly posts 15 in frame 9.

FIG. 10 shows a section view A-A of a luminaire assembly, comprising of OLED shade 1 assembled into a cone shape and fixed thereto by way of frame 9 and an interior mounting plate 19 on opposing sides of the of OLED shade 1 sandwiching the portions of OLED shade 1 proximal to joint edges 4 whereby it is considered assembled with fastening means 17, portions of the frame 9, such as assembly posts 15, passing through the assembly positions 14 to touch and mount to the mounting plate 19 to retain the OLED shade 1 fixedly to its desired shape so as not to crush or undesirably compress the OLED shade 1 during assembly.

Conductors 20 are connected to power source 11 within a channel 21 within the frame 9. The luminaire assembly of OLED shade 1, frame 9 and other components is supported by support means 10.

FIG. 11 shows a perspective view of the frame 9 supported by support means 10, in the form of a lamp-stand, showing an unobstructed view of assembly means without the OLED shade 1 or mounting plate 19. Power source 11 is accessible by way of channel 21 in frame 9, whereat it can be connected to conductors 13 as seen in FIG. 10. An interior portion of frame 9 reveals assembly posts 15 that are used to retain the OLED shade 1 into position by way of assembly holes 14 and relief notches 16 as seen in FIG. 6, to which fastening means 17, such as hardware, can be fixed thereto by way of fastening positions 18, retaining the mounting plate 19 and OLED shade 1 into final assembly.

1-9. (canceled)

10. A lamp comprising:
a support (9);
a flat flexible organic light emitting diode (OLED) panel (1) curled around an axis (5) to form a body resembling a lamp-shade solely by fixing two opposed edges (4) of the flexible OLED panel (1) together to define a seam (6);
a mounting (19) positioned along the seam (6) to mount the flexible OLED panel (1) to the support, and the flexible OLED panel being supported solely by the support (9) in an operative position.

11. The lamp of claim 10, wherein a power source (11) extends through a channel (21) in the support (9) to provide power to flexible OLED panel (1).

12. The lamp of claim 10, wherein a mounting plate (19) is the mounting used to mount the flexible OLED panel (1) to the support (9).

13. The lamp of claim 10, wherein the flexible OLED panel (1) is elongated with the two opposed edges (4) connected by an inner edge (2) with a concave curvature and an outer edge (3) with a convex curvature, and when the lamp-shade is formed there is a nominally circular aperture (7) along an inner edge (2) and a relatively larger nominally circular aperture (8) along an outer edge (3).

14. The lamp of claim 10, wherein the seam (6) is held together by fasteners (15, 17).

15. The lamp of claim 14, wherein opposed edges (4) have non-emitting borders (12), and openings (14, 16) are positioned in borders (12) to receive fasteners (15, 17).

16. The lamp of claim 11, wherein conductors (13) are provided to complete an electrical connection of flexible OLED panel (1) with the power source (11).
